(19) United States
(12) Patent Application Publication
(10) Pub. No.: US 2019/0393504 A1
(43) Pub. Date: Dec. 26, 2019

(54) METHOD FOR MANUFACTURING ACTIVATED CARBON USING COFFEE BEAN EXTRACT AND ELECTRODE FOR BATTERY COMPRISING SAME

(71) Applicant: National Institute Of Forest Science, Seoul (KR)

(72) Inventors: Sun Young Lee, Seoul (KR); Sang Young Lee, Busan (KR); Jong Tae Yoo, Ulsan (KR); Dong Gue Lee, Ulsan (KR); Sang Jin Chun, Namyangju-Si (KR); Sang Bum Park, Seoul (KR); Don Ha Choi, Seoul (KR)

(73) Assignee: National Institute Of Forest Science, Seoul (KR)

(21) Appl. No.: 16/466,995

(22) PCT Filed: Dec. 6, 2016
(86) PCT No.: PCT/KR2016/014236

§ 371 Date: Jun. 5, 2019

(30) Foreign Application Priority Data
Dec. 6, 2016 (KR) 10-2016-0164911

(51) Int. Cl. H01M 4/587; C01B 32/318; C01B 32/348; H01M 4/133

(52) U.S. Cl. CPC H01M 4/587; C01B 32/318; C01B 32/348; H01M 4/133; C01P 2006/12; H01M 2004/021; C01P 2002/85; C01P 2004/03; C01P 2002/82; C01P 2002/72; C01P 2006/40

(57) ABSTRACT

The present invention relates to a method for manufacturing activated carbon using a coffee bean extract, and an electrode for a battery comprising same. The method for manufacturing activated carbon, according to the present invention, is safe for the human body by using an extract obtained from food, such as coffee beans, as an activation catalyst when carbidizing cellulose, and allows easy maintenance and repair of processing equipment, thereby providing the advantages of excellent productivity, economic feasibility, and also of being environmentally friendly due to utilization of discarded food waste. In addition, activated carbon manufactured by the method has a large specific surface area and has fine pores having a diameter of no more than 2 nm, thereby being useful when applied to electrode materials for a super capacitor, among others.

### TECHNICAL FIELD

The present invention relates to a method of preparing activated carbon using a coffee bean extract and an electrode for a battery including the activated carbon.

### BACKGROUND ART

Activated carbon is amorphous carbon having a porous structure, and is well known as a material exhibiting excellent adsorption characteristics in gas phases and liquid phases. Due to having such characteristics, activated carbon is used in various fields, mainly in refining processes, atmospheric purification, and the like, and the range of application is gradually expanding into the field of capacitor electrode materials and the like, for which fast-charging/discharging characteristics, longevity, eco-friendliness, wide operating temperature conditions, and the like are required.

Such activated carbon is generally prepared using the cokes, pitches, resins, or the like obtained from coconut shells, sawdust, coal, or petroleum as the raw material. Although it is required for activated carbon used as a capacitor electrode material to have an appropriate specific surface area, an appropriate pore diameter, an appropriate particle size, and the like as well as high electrical conductivity, the conventional and commercially available activated carbon has a relatively large particle size, and there is a difficulty in controlling the pore size thereof. Moreover, as disclosed in Korean Laid-open Patent Application No. 2015-0066925, the controlling of the particle size or pore size of activated carbon requires an additional chemical activation process using a high-concentration potassium hydroxide (KOH) aqueous solution or zinc chloride (ZnCl₂) which is harmful to the human body and is highly corrosive, and therefore, there is a limit in that the health of workers may be harmed, the lifetime of the process equipment is short, and the maintenance and repair cost of the equipment is high.

Therefore, there is a desperate need to develop a technique for preparing activated carbon having a large specific surface area and a small pore size in an economical manner without using an alkali metal hydroxide or alkali metal chloride which is harmful to the human body and is highly corrosive.

### DISCLOSURE

### Technical Problem

The present invention is directed to providing a method of preparing activated carbon having a large specific surface area and a small pore size in an economical manner without using an alkali metal hydroxide or alkali metal chloride which is harmful to the human body and is highly corrosive.

In addition, the present invention is directed to providing an electrode for a battery, which is produced using the activated carbon prepared by the above method.

### Technical Solution

One aspect of the present invention provides a method of preparing activated carbon, which includes:

heat-treating cellulose which has absorbed an activation solution to prepare the activated carbon, wherein the activation solution is an extract derived from one or more selected from the group consisting of coffee beans, peanuts, almonds, peas, avocados, kelps, sea mustard, green algae, and red seaweeds.

Another aspect of the present invention provides an electrode for a battery including the activated carbon.

### Advantageous Effects

The method of preparing activated carbon according to the present invention uses an extract derived from food, such as coffee beans, as an activation catalyst for the carbonization of cellulose, and thus is safe for the human body. In addition, the method provides excellent productivity and economic feasibility due to the ease of maintenance and repair of process equipment, and is also eco-friendly in that discarded food waste, such as coffee, can be used. Moreover, the activated carbon prepared by the method has a large specific surface area and a pore diameter as small as 2 nm or less, and thus can be usefully employed as a supercapacitor electrode material and the like.

### DESCRIPTION OF DRAWINGS

FIG. 1 is an image for schematically illustrating a method of preparing activated carbon according to the present invention.

FIGS. 2A-2B show images of activated carbon prepared according to the present invention (Example 3, FIG. 2A) and of activated carbon prepared through the carbonization of paper containing cellulose (Comparative Example 1, FIG. 2B), analyzed by energy dispersive spectroscopy (EDS) and scanning electron microscopy (SEM; acceleration voltage: 20 eV).

FIGS. 3A-3B show graphs of activated carbon prepared according to the present invention (Example 3) measured by (FIG. 3A) Raman spectroscopy and (FIG. 3B) X-ray diffraction (XRD).

FIGS. 4A-4C show graphs of activated carbon prepared according to the present invention (Example 3) measured by X-ray photoelectron spectroscopy (XPS).

FIGS. 5A-5B show graphs for measuring the (FIG. 5A) pore volume and (FIG. 5B) average pore diameter of activated carbon prepared according to the present invention (Example 3).

FIGS. 6A-6D are a set of graphs for measuring electrical properties of supercapacitors each including, in an electrode thereof, activated carbon prepared according to the present invention (Example 3) or activated carbon prepared through the carbonization of paper containing cellulose (Comparative Example 1): (FIG. 6A): cyclic voltage-current (cyclic voltammetry) graph, (FIG. 6B): galvanostatic charge/discharge graph, showing voltage as a function of time, (FIG. 6C): charge/discharge cycle evaluation graph, (FIG. 6D): impedance graph.

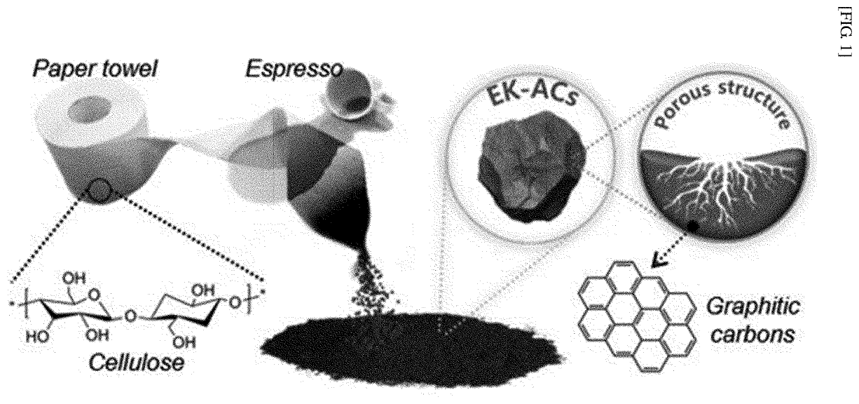

### BEST MODE

The present invention may be modified into various forms and include various embodiments, and specific embodiments thereof will be illustrated in the accompanying drawings and described in more detail in the “Modes of the Invention.”

It is to be understood, however, that the invention is not limited to the specific embodiments but includes all modifications, equivalents, or alternatives encompassed within the spirit and technical scope of the invention.

In the present invention, the term “include,” “contain,” “comprise,” or “have” is intended to indicate the presence of a feature, number, step, operation, constituent element, part, or any combination thereof described in the specification, but it should be understood that the possibility of the presence or addition of one or more other features, numbers, steps, operations, constituent elements, parts, or any combination thereof is not precluded.

Further, it should be understood that the accompanying drawings in the present invention are illustrated in an enlarged or reduced size for the convenience of explanation.

The present invention relates to a method of preparing activated carbon and an electrode for a battery including the activated carbon.

Activated carbon is an amorphous carbon having a porous structure, and is well known as a material exhibiting excellent adsorption characteristics in gases and liquids. Due to having such characteristics, activated carbon is used in various fields, mainly in refining processes, atmospheric purification, and the like, and the range of application is gradually expanding into the field of capacitor electrode materials and the like, for which fast-charging/discharging characteristics, longevity, eco-friendliness, wide operating temperature conditions, and the like are required.

Such activated carbon is generally prepared using the cokes, pitches, resins, or the like obtained from coconut shells, sawdust, coal, or petroleum as the raw material. Although it is required for activated carbon used as a capacitor electrode material to have an appropriate specific surface area, an appropriate pore diameter, an appropriate particle size, and the like as well as high electrical conductivity, the conventional and commercially available activated carbon has a relatively large particle size, and there is a difficulty in controlling the pore size thereof. Moreover, the controlling of the particle size or pore size of activated carbon requires an additional chemical activation process using a high-concentration potassium hydroxide (KOH) aqueous solution or zinc chloride (ZnCl₂) which is harmful to the human body and is highly corrosive, and therefore, there is a limit in that the health of workers may be harmed, the lifetime of the process equipment is short, and the maintenance and repair cost of the equipment is high.

Hence, the present invention provides a method of preparing activated carbon using a coffee bean extract and an electrode for a battery including the activated carbon.

The method of preparing activated carbon according to the present invention uses an extract derived from food, such as coffee beans, as an activation catalyst for the carbonization of cellulose, and thus is safe for the human body. In addition, the method provides excellent productivity and economic feasibility due to the ease of maintenance and repair of process equipment, and is also eco-friendly in that discarded food waste, such as coffee, can be used. Moreover, the activated carbon prepared by the method has a large specific surface area and a pore diameter as small as 2 nm or less, and thus can be usefully employed as a supercapacitor electrode material and the like.

Hereinafter, the present invention will be described in more detail.

In one exemplary embodiment thereof, the present invention provides a method of preparing activated carbon, which includes the step of heat-treating cellulose which has absorbed an activation solution to prepare the activated carbon,

wherein the activation solution is an extract derived from one or more selected from the group consisting of coffee beans, peanuts, almonds, peas, avocados, kelps, sea mustard, green algae, and red seaweeds.

The method of preparing activated carbon according to the present invention may speed up the carbonization of cellulose, which is a carbon source, and may prepare activated carbon using an activation solution extracted from food as an activation catalyst for inducing the microporous structure of the activated carbon being prepared.

Specifically, in the present invention, the activated carbon may be obtained by soaking cellulose, a carbon source, in an activation solution to allow the activation solution to be absorbed into the cellulose, drying the cellulose which has absorbed the activation solution, and then carbonizing the dried cellulose by heat-treating the same.

Here, the activation solution may be an extract obtained from a food with a high content of metal ions such as potassium ions (K⁺). Specifically, the activation solution may be obtained through hot-water extraction of one or more among the following: beans such as coffee beans, peanuts, almonds, and peas; fruits such as avocados, or marine algae such as kelps, sea mustard, green algae, and red seaweeds. More specifically, the activation solution may be obtained through hot-water extraction of one or more selected from the group consisting of coffee beans, peanuts, almonds, and peas. For example, the activation solution may be obtained through hot-water extraction of coffee beans.

The hot-water extraction is a method of extracting a water-soluble component from a material using high-temperature water, wherein the temperature of the water may be 80° C. or more. For example, the temperature of the water may be in the range of 90° C. to 110° C., 90° C. to 95° C., 95° C. to 100° C., 100° C. to 105° C., 95° C. to 105° C., or 98° C. to 102° C.

In addition, the hot-water extraction may be performed under the pressure condition of atmospheric pressure (1 bar) or more. Specifically, the hot-water extraction may be performed under the pressure condition of 1 bar to 20 bar, more specifically, under the pressure condition of 1 bar to 15 bar, 1 bar to 10 bar, 1 bar to 5 bar, 3 bar to 5 bar, 3 bar to 4 bar, 5 bar to 15 bar, 5 bar to 10 bar, 10 bar to 15 bar, 13 bar to 15 bar, 14 bar to 17 bar, 15 bar to 20 bar, or 8 bar to 10 bar.

Further, the activation solution may contain a large amount of one or more metal ions selected from the group consisting of potassium ions (K⁺), sodium ions (Na⁺), and zinc ions (Zn²⁺). Due to being obtained through hot-water extraction of a food with a high potassium content under the above-described pressure and temperature conditions, the activation solution being used in the present invention contains a large amount of potassium ions (K⁺). Specifically, the content of each type of metal ion in the activation solution may be 50 mg/L or more, more specifically, 50 mg/L or more, 100 mg/L or more, 150 mg/L or more, 200 mg/L or more, 250 mg/L or more, 300 mg/L or more, 350 mg/L or more, 400 mg/L or more, 500 mg/L or more, 50 mg/L to 10,000 mg/L, 100 mg/L to 9,000 mg/L, 500 mg/L to 9,000 mg/L, 500 mg/L to 7,000 mg/L, 500 mg/L to 6,000 mg/L, 1,000 mg/L to 9,000 mg/L, 5,000 mg/L to 9,000 mg/L, 6,000 mg/L to 10,000 mg/L, 500 mg/L to 5,000 mg/L, 500 mg/L to 4,000 mg/L, mg/L, 3,000 mg/L to 5,000 mg/L, 3,000 mg/L to 4,000 mg/L, 3,500 mg/L to 4,500 mg/L, 4,000 mg/L to 5,000 mg/L, 1,000 mg/L to 3,000 mg/L, 2,000 mg/L to 3,000 mg/L, 2,000 mg/L to 2,500 mg/L, or 2,000 mg/L to 2,200 mg/L. For example, the activation solution may be obtained through hot-water extraction of coffee beans, to have the potassium ion (K⁺) content of 2,100±50 mg/L. In the present invention, the content of metal ions in the activation solution is adjusted within the above-described range, and thus the rate of carbonization of cellulose can be increased, and the surface of the activated carbon can be activated to both increase porosity and miniaturize the pore diameter, thereby inducing the microporous structure of activated carbon.

In one example, the activated carbon prepared according to the present invention may have an average pore diameter of 2 nm or less, specifically, 0.5 nm to 1.5 nm, 0.5 nm to 1.0 nm, or 1.0 nm to 1.5 nm. In addition, the activated carbon may have an average specific surface area of 30 m²/g to 2,000 m²/g, specifically, 50 m²/g to 2,000 m²/g, 50 m²/g to 1,500 m²/g, 50 m²/g to 1,000 m²/g, 50 m²/g to 500 m²/g, 200 m²/g to 500 m²/g, 200 m²/g to 400 m²/g, 200 m²/g to 300 m²/g, 230 m²/g to 270 m²/g, 100 m²/g to 300 m²/g, 100 m²/g to 200 m²/g, 250 m²/g to 300 m²/g, 300 m²/g to 500 m²/g, or 250 m²/g to 260 m²/g.

Meanwhile, the cellulose being used as the carbon source in the present invention may be obtained from a green plant, a green marine alga, or a microorganism. For example, the cellulose may be the cellulose in the form of fibers which is obtained from wood, and specifically, it may be paper composed of cellulose fibers. When paper obtained from wood is used as the cellulose, the cost normally required for preparing a raw material can be saved.

There is no particular limitation to the amount of the activation solution to be absorbed into the cellulose, as long as the amount is sufficient for wetting the cellulose. For example, 0.001 ml to 0.1 ml of the activation solution may be absorbed into a unit weight (1 mg) of the cellulose, and specifically, 0.001 ml to 0.05 ml, 0.001 ml to 0.03 ml, 0.001 ml to 0.02 ml, 0.001 ml to 0.01 ml, 0.01 ml to 0.5 ml, 0.01 ml to 0.03 ml, 0.01 ml to 0.02 ml, 0.02 ml to 0.03 ml, 0.015 ml to 0.025 ml, 0.05 ml to 0.1 ml, 0.03 ml to 0.05 ml, 0.04 ml to 0.08 ml, or 0.08 ml to 0.1 ml of the activation solution may be absorbed into a unit weight (1 mg) of the cellulose. In the present invention, the amount of absorbed activation solution is adjusted within the above-described range, and thus the amount of potassium ions (K⁺) remaining in the cellulose can be optimized.

In addition, the cellulose which has absorbed the activation solution may be heat-treated in a temperature range in which paper can be carbonized. Specifically, the heat treatment may be performed at 100° C. to 1,000° C., more specifically, at 100° C. to 900° C., 100° C. to 800° C., 100° C. to 700° C., 100° C. to 600° C., 500° C. to 1,000° C., 500° C. to 900° C., 500° C. to 800° C., 200° C. to 700° C., 300° C. to 700° C., 350° C. to 700° C., 400° C. to 700° C., 500° C. to 700° C., 550° C. to 650° C., 100° C. to 300° C., 150° C. to 300° C., 200° C. to 300° C., 220° C. to 280° C., or 240° C. to 270° C. For example, due to the activation solution being absorbed, the cellulose of the present invention starts to decompose at 255±2° C., which is lower than the temperature at which conventional cellulose is carbonized; therefore, it may be possible to effectively carbonize the cellulose of the present invention even at a lower temperature than the temperature at which conventional cellulose is carbonized.

Further, the heat treatment may be performed for 5 minutes to 300 minutes, specifically, for 5 minutes to 250 minutes, 5 minutes to 200 minutes, 10 minutes to 250 minutes, 30 minutes to 250 minutes, 60 minutes to 250 minutes, 100 minutes to 250 minutes, 5 minutes to 180 minutes, 5 minutes to 150 minutes, 5 minutes to 130 minutes, 10 minutes to 130 minutes, 20 minutes to 200 minutes, 20 minutes to 150 minutes, 20 minutes to 130 minutes, 30 minutes to 200 minutes, 30 minutes to 180 minutes, 30 minutes to 150 minutes, 30 minutes to 130 minutes, 60 minutes to 180 minutes, 60 minutes to 150 minutes, 60 minutes to 130 minutes, 60 minutes to 100 minutes, 100 minutes to 200 minutes, 100 minutes to 180 minutes, 100 minutes to 150 minutes, 100 minutes to 130 minutes, 5 minutes to 15 minutes, 5 minutes to 35 minutes, 20 minutes to 40 minutes, 170 minutes to 190 minutes, or 110 minutes to 130 minutes. In the present invention, the duration of the heat treatment of cellulose is adjusted within the above-described range, so that the specific surface area of the activated carbon being prepared can be maximized. For example, the activated carbon prepared by heat-treating cellulose for 120 minutes may have an average specific surface area of 255±2 m²/g.

In one embodiment thereof, the present invention provides an electrode for a battery, which includes

activated carbon which has been prepared from cellulose using a hot-water extract of one or more selected from the group consisting of coffee beans, peanuts, almonds, peas, avocados, kelps, sea mustard, green algae, and red seaweeds.

Due to including the activated carbon which has been prepared from cellulose using a hot-water extract of one or more selected from the group consisting of coffee beans, peanuts, almonds, peas, avocados, kelps, sea mustard, green algae, and red seaweeds as an electrode active material, the electrode for a battery according to the present invention not only can be produced at a low cost, but also exhibits a high capacitance.

### MODES OF THE INVENTION

Hereinafter, the present invention will be described in more detail with reference to Examples and Experimental Examples.

However, the following Examples and Experimental Examples are merely illustrative of the present invention and are not intended to limit the scope of the present invention thereto.

### Examples 1 to 4. Preparation of Activated Carbon

The espresso obtained through hot-water extraction of coffee beans under the conditions of 95±1° C. and 9 bar was prepared as the activation solution. When measured by inductively coupled plasma optical emission spectrometry (ICP-OES; 700-ES manufactured by Varian Medical Systems, Inc.), the prepared espresso solution contained 2112±10 mg/L of potassium ions (K⁺). Thereafter, paper (Kimwipes® manufactured by Yuhan-Kimberly) measuring 10.7 cm (width)×21 cm (length) was soaked in the prepared espresso (20 ml) to allow the espresso to be absorbed thereinto, and was dried at 120±2° C. for 6±0.5 hours. Once the paper which had absorbed the espresso was dried, it was heat-treated at 600±10° C. under a nitrogen atmosphere, thereby preparing activated carbon. The duration of heat treatment is shown in Table 1 below, and the amount of espresso absorbed into the paper was 0.02±0.002 ml per unit weight (1 mg) of the paper.

TABLE 1

| | Duration of heat treatment |
|---|---|
| Example 1 | 10 minutes |
| Example 2 | 30 minutes |
| Example 3 | 120 minutes |
| Example 4 | 180 minutes |

### Comparative Example 1

Distilled water (containing 3 mg/L of K⁺ as measured by ICP-OES) was prepared. Thereafter, paper (Kimwipes® manufactured by Yuhan-Kimberly) measuring 10.7 cm (width)×21 cm (length) was soaked in the prepared distilled water to allow the distilled water to be absorbed thereinto, and was dried at 120±2° C. for 6±0.5 hours. Once the paper was dried, it was heat-treated at 600±10° C. under a nitrogen atmosphere for 2 hours, thereby preparing activated carbon.

### Example 5. Fabrication of Supercapacitor

The activated carbon prepared in Example 3, multi-walled carbon nanotubes (MWNTs), and polytetrafluoroethylene (PTFE) were mixed in a weight ratio of 85:10:5 (w/w/w), and the mixture was pressed onto a porous nickel (nickel foam) current collector using a roll press machine, thereby producing an electrode.

Thereafter, a 6 M KOH aqueous solution and Celgard 3501 (thickness=25 μm) were prepared as an electrolyte and a separator, respectively, and were packaged along with the produced electrode into a coin type cell (2032-type), thereby fabricating a double-layer supercapacitor.

### Comparative Example 2

A double-layer supercapacitor was fabricated in the same manner as in Example 5 except that the activated carbon prepared in Comparative Example 1 was used instead of the activated carbon prepared in Example 3.

### Experimental Example 1

The following experiment was conducted to identify the formation temperature, composition, and structure of activated carbons prepared according to the present invention.

(A) Determination of Formation Temperature of Activated Carbon

In order to investigate what effect the use of espresso obtained through hot-water extraction of coffee beans as an activation solution has on the carbonization of cellulose, the activation solution was prepared according to Example 1, and paper (Kimwipes® manufactured by Yuhan-Kimberly) measuring 10.7 cm (width)×21 cm (length) was soaked in the prepared activation solution to allow the espresso to be absorbed into the paper. Thereafter, the paper was dried at 120±2° C. for 6±0.5 hours, and the dried paper was subjected to thermogravimetric analysis. Here, the thermogravimetric analysis was performed under a nitrogen atmosphere while increasing the temperature at a rate of 5±0.1° C./min. Also, paper (Kimwipes® manufactured by Yuhan-Kimberly) measuring 10.7 cm (width)×21 cm (length) which had not absorbed espresso was used as the control group, and the results are shown in Table 2 below.

TABLE 2

| | Pyrolysis temperature |
|---|---|
| Paper of Example 1 | 254 ± 2° C. |
| Control paper | 322 ± 2° C. |

Table 2 shows that the pyrolysis temperature of the paper of Example 1, which had absorbed espresso, was 254±2° C., which was lower than that of the control paper, which had not absorbed espresso, by about 68° C.

This result indicates that the potassium ions (K⁺) present in espresso accelerate the carbonization of cellulose, allowing cellulose to be carbonized even at lower temperatures.

(B) Analysis of Composition of Activated Carbon

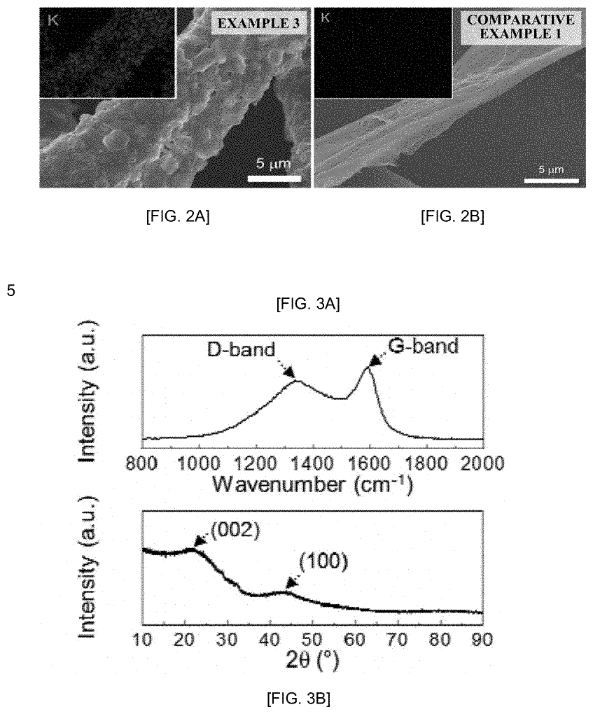

To analyze the composition of activated carbon, the activated carbons prepared in Examples 1 to 3 and Comparative Example 1 were observed under a scanning electron microscope (SEM; acceleration voltage: 20 eV) equipped with an energy dispersive spectroscopy (EDS) instrument. In addition, the activated carbons were analyzed by Raman spectroscopy, X-ray diffraction (XRD), and X-ray photoelectron spectroscopy (XPS; K-alpha™ XPS system manufactured by Thermo Scientific™) Here, the XRD was conducted under the conditions of 40 kV and 40 mA (CuKα radiation, λ=0.154056 nm), and results thereof are shown in FIGS. 2 to 4. First, FIGS. 2A-2B show that the surface of the activated carbon of Example 3, which had been prepared according to the present invention, had been activated and thus was rough, and when subjected to EDS, the activated carbon of Example 3 was found to contain potassium ions (K⁺). On the other hand, the activated carbon of Comparative Example 1, where espresso (i.e., coffee extract) had not been used to prepare the activated carbon, was found to have a smooth surface and not contain potassium ions.

In addition, FIGS. 3A-3B show that the activated carbon of Example 3 produced (FIG. 3A) Raman spectroscopy peaks at 1344±2 cm⁻¹ and 1593±2 cm⁻¹, indicating activated carbon, and (FIG. 3B) XRD peaks at 23±0.5° and 44±0.5°, respectively indicating the [0,0,2] plane and [1,0,0] plane of activated carbon.

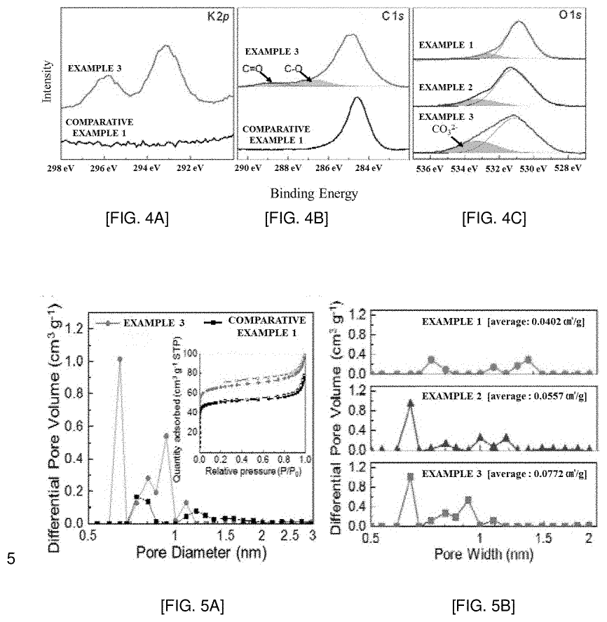

Further, FIGS. 4A-4C shows that the activated carbon of Example 3 produced energy peaks at 293±1 eV and 296±1 eV, indicating the binding of potassium, and energy peaks at 287±1 eV, 289±1 eV, 533±1 eV, and the like, indicating the binding of functional groups such as a carbonyl group (—C(═O)— group), a carbonate group (CO₃²⁻ group), or the like. On the other hand, the activated carbon of Comparative Example 1, where espresso had not been used, did not produce such peaks.

The results demonstrate that the potassium ions (K⁺) present in the espresso obtained through hot-water extraction of coffee beans and absorbed into the paper accelerate the carbonization of cellulose and induce the microporous structure of the carbonized cellulose when the paper is being pyrolyzed to prepare activated carbon.

(C) Analysis of Structure of Activated Carbon

The activated carbons prepared in Examples 1 to 3 and Comparative Example 1 were measured for a BET specific surface area, a pore volume, and an average pore diameter. Here, the BET specific surface area was measured using a physisorption analyzer (ASAP2020 manufactured by Micromeritics) at 77 K under a nitrogen atmosphere, and results thereof are shown in Table 3 and FIGS. 5A-5B.

TABLE 3

| | Duration of | Average BET specific | Average pore |
|---|---|---|---|
| | heat treatment | surface area [m²/g] | volume [cm³/g] |
| Example 1 | 10 minutes | 126.1 ± 5 | 0.0402 ± 0.005 |
| Example 2 | 30 minutes | 193.7 ± 5 | 0.0557 ± 0.005 |
| Example 3 | 120 minutes | 255.8 ± 5 | 0.0772 ± 0.005 |
| Example 4 | 180 minutes | 110.2 ± 5 | 0.0323 ± 0.005 |
| Comparative | 120 minutes | 198.9 ± 5 | — |
| Example 1 | | | |

Table 3 and FIG. 5A show that the activated carbon of Example 3, which had been prepared according to the present invention, had a large average BET specific surface area and a large average pore volume compared to the activated carbon of Comparative Example 1, where espresso had not been used to prepare the activated carbon.

In addition, FIG. 5B shows that the average pore volume increased, and the average pore diameter decreased with the increasing duration of the heat treatment of activated carbon.

The results suggest that the tendency of potassium ions (K⁺) present in espresso and remaining in cellulose to induce the microporous structure of activated carbon during carbonization of the cellulose is affected by the duration of heat treatment.

### Experimental Example 2

The following experiment was conducted to evaluate the performance of a supercapacitor including activated carbon prepared according to the present invention in an electrode thereof.

Specifically, the supercapacitors fabricated in Example 5 and Comparative Example 2 were measured for i) cyclic voltage-current characteristics (cyclic voltammetry), ii) voltage as a function of time during galvanostatic charging and discharging, iii) a change in capacitance retention according to charging and discharging, and iv) impedance.

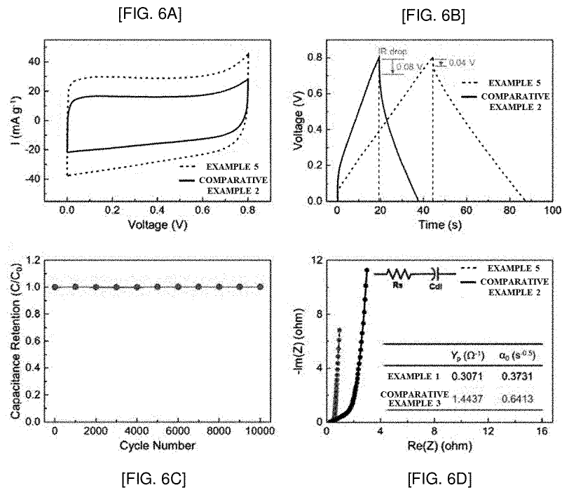

Here, the cyclic voltage-current characteristics were determined at a scan rate of 1.0 mV·s⁻¹ in the potential range of 0 to 0.8 V, and the voltage as a function of time during galvanostatic charging and discharging was measured at a current density of 0.5 A·g⁻¹ for 100 seconds. The capacitance retention according to charging and discharging was determined as the capacitance retention upon 10,000 charge/discharge cycles at a current density of 0.5 A·g⁻¹, and the impedance was measured using a TLM-PSD model device in the frequency range of 10⁻² Hz to 10⁻⁵ Hz. In addition, the total ionic conductance (Yp) and penetrability coefficient (α₀) of the activated carbons prepared in Example 3 and Comparative Example 1 also were determined while measuring the impedance, and results thereof are shown in FIG. 6.

As shown in FIGS. 6A to 6D, the supercapacitor of Example 5, which included activated carbon prepared according to the present invention in an electrode thereof, exhibited a high charge/discharge capacitance compared to the supercapacitor of Comparative Example 2. Specifically, the supercapacitor of Example 5 exhibited a specific capacitance of 131±5 F/g while the supercapacitor of Comparative Example 2 exhibited a specific capacitance of 64±5 F/g. In addition, the supercapacitor of Example 5 retained a constant charge/discharge capacitance even after 10,000 charge/discharge cycles.

From the above results, it can be seen that the activated carbon prepared according to the present invention has excellent electrochemical properties by having a large specific surface area and a microporous structure with a pore diameter as small as 2 nm or less, and thus can be usefully employed as a supercapacitor electrode material and the like.

### INDUSTRIAL APPLICABILITY

The method of preparing activated carbon according to the present invention uses an extract derived from food, such as coffee beans, as an activation catalyst for the carbonization of cellulose, and thus is safe for the human body. In addition, the method provides excellent productivity and economic feasibility due to the ease of maintenance and repair of process equipment, and is also eco-friendly in that discarded food waste, such as coffee, can be used. Moreover, the activated carbon prepared by the method has a large specific surface area and a pore diameter as small as 2 nm or less, and thus can be usefully employed as a supercapacitor electrode material and the like.

1. A method of preparing activated carbon, comprising heat-treating cellulose which has absorbed an activation solution to prepare the activated carbon,
wherein the activation solution is an extract derived from one or more selected from the group consisting of a coffee bean, a peanut, an almond, a pea, an avocado, a kelp, sea mustard, a green alga, and a red seaweed.

2. The method of claim 1, wherein the activation solution is obtained through hot-water extraction of one or more selected from the group consisting of a coffee bean, a peanut, an almond, and a pea.

3. The method of claim 1, wherein the activation solution is obtained through hot-water extraction under a pressure of 1 bar to 20 bar.

4. The method of claim 1, wherein the activation solution includes one or more types of metal ions selected from the group consisting of potassium ions (K⁺), sodium ions (Na⁺), and zinc ions (Zn²⁺),
wherein each type of the metal ions is included at a concentration of 50 mg/L or more.

5. The method of claim 1, wherein the cellulose is obtained from a green plant, a green marine alga, or a microorganism.

6. The method of claim 1, wherein the heat treatment is performed at a temperature of 100° C. to 1,000° C.

7. The method of claim 1, wherein the heat treatment is performed for 5 minutes to 300 minutes.

8. The method of claim 1, further comprising, prior to the heat-treating of the cellulose which has absorbed the activation solution to prepare the activated carbon:
immersing the cellulose in the activation solution; and
drying the cellulose which has been subjected to immersion.

9. The method of claim 8, wherein an amount of the activation solution absorbed per unit weight (1 mg) of the cellulose is in a range of 0.001 ml to 0.1 ml.

10. The method of claim 1, wherein the activated carbon has an average specific surface area of 30 m²/g to 2,000 m²/g.

11. An electrode for a battery, comprising activated carbon which has been prepared from cellulose using a hot-water extract of one or more selected from the group consisting of a coffee bean, a peanut, an almond, a pea, an avocado, a kelp, sea mustard, a green alga, and a red seaweed.
